(19) United States
(12) Patent Application Publication
(10) Pub. No.: US 2025/0117481 A1
(43) Pub. Date: Apr. 10, 2025

(54) DETECTION OF MALWARE USING DEDUPLICATION SIGNATURES

(71) Applicant: International Business Machines Corporation, Armonk, NY (US)

(72) Inventors: Fraser Iain MacIntosh, Reading (GB); Christopher J. Vollmar, Mississauga (CA)

(21) Appl. No.: 18/503,524

(22) Filed: Nov. 7, 2023

(30) Foreign Application Priority Data
Oct. 4, 2023 (GB) 2315198.8

(51) Int. Cl. G06F 21/56

(52) U.S. Cl. CPC G06F 21/565; G06F 21/566; G06F 2221/034

(57) ABSTRACT

A computer-implemented method, computer program product, and computer system for detection of malware is provided. The computer-implemented method includes: obtaining a deduplication signature of a file identified as being suspicious to obtain suspect signature blocks. The computer-implemented method further includes storing the suspect signature blocks in a searchable format store. The computer-implemented method may also include outputting the suspect signature block store for use in identification of other instances of the suspect data blocks.

### BACKGROUND

The present invention relates to detection of malware, and more specifically, to detection of malware using deduplication signatures.

Secondary storage systems, such as backup and archive, have the option to store data in a deduplicated format. Deduplication of data is also a common technique for wide area network (WAN) acceleration and other use cases. In addition, it is also increasingly common for primary storage systems to offer data deduplication options.

In deduplication systems, various methods are used to reduce the physical storage required to represent data which are being stored or transmitted. Typically, this is a method to identify non-unique blocks of data and give them a universally unique identification (such as a computed hash value) which enables data built from previously encountered blocks to be represented using just references to the blocks which have been previously stored from a database engine.

The practical upshot is that individual chunks of deduplicated data which are written to a storage system, can represent elements of multiple different files or data streams from multiple different clients. Similarly, in network acceleration (such as Wide Area Network (WAN) Acceleration) this can represent data which has come from multiple network nodes. In the case of primary storage, the deduplicated data are potentially representative of multiple client filesystems.

In secondary storage environments (such as but not limited to backup, data protection, and archive systems), it is common to use the data stored for various non-production functions, such as analytics, testing, off-line processing, etc. One of the features that has become more common is cyber-resilience and vulnerability detection. That is the ability to use the stored data to observe tell-tale signs of risk, typically malware, malicious attack, etc.

Malware file sizes have been increasing in recent years and are no longer a few hundred bytes. Often code for malware is distributed in plain text or obfuscated text formats or as fully compiled executables.

### SUMMARY

According to an aspect of the present invention there is provided a computer-implemented method for detection of malware, said method comprising: obtaining a deduplication signature of a file identified as being suspicious to obtain a plurality of suspect signature blocks; storing the plurality of suspect signature blocks in a searchable format store; and outputting a suspect signature block store for use in identification of other instances of suspect signature data blocks.

This has the advantage of using deduplication as a method to identify a spread of a potentially suspicious file.

According to another aspect of the present invention there is provided a system for detection of malware, comprising: a processor and a memory configured to provide computer program instructions to the processor to execute the function of the components: a suspicious file deduplication component for obtaining a deduplication signature of a file identified as being suspicious to obtain a plurality of suspect signature blocks; a suspect block storing component for the plurality of suspect signature blocks in a searchable format store; and an output component for outputting a suspect signature block store for use in identification of other instances of suspect signature data blocks.

According to a further aspect of the present invention there is provided a computer program product for detection of malware, the computer program product comprising a computer readable storage medium having program instructions embodied therewith, the program instructions executable by a processor to cause the processor to: obtain a deduplication signature of a file identified as being suspicious to obtain a plurality of suspect signature blocks; store the plurality of suspect signature blocks in a searchable format store; and a suspect signature block store for use in identification of other instances of suspect signature data blocks.

The computer readable storage medium may be a non-transitory computer readable storage medium and the computer readable program code may be executable by a processing circuit.

### BRIEF DESCRIPTION OF THE DRAWINGS

Embodiments of the present invention will now be described, by way of example only, with reference to the accompanying drawings:

FIG. 1 is a flow diagram of an example embodiment of a method in accordance with embodiments of the present invention;

FIG. 2 is a flow diagram of an example embodiment of the overall method in accordance with embodiments of the present invention;

FIG. 3A is a flow diagram of an example embodiment of an aspect of the method of FIG. 2 in accordance with embodiments of the present invention;

FIG. 3B is a flow diagram of another example embodiment of the aspect of FIG. 3A in accordance with embodiments of the present invention;

FIG. 4 is a flow diagram of an example embodiment of an aspect of the method of FIG. 2 in accordance with embodiments of the present invention;

FIG. 5 is a schematic diagram illustrating an example embodiment of the method in accordance with embodiments of the present invention;

FIG. 6 is a block diagram of an example embodiment of a system in accordance with embodiments of the present invention; and

FIG. 7 is a block diagram of an example embodiment of a computing environment for the execution of at least some of the computer code involved in performing the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Embodiments of a method, system, and computer program product are provided that use deduplicated data to identify systems which are handling the same common blocks of data as those which have been identified as malware. The common blocks have a high probability of either being from infected systems or from systems which are disseminating the malware infected files.

The described method is able to find and identify malware signatures in environments that use deduplication by using the deduplication database and catalogue of pointers in the environment. The method finds potential malware infections based on their common deduplication patterns.

Deduplication is commonly known in data storage environments managed by a secondary storage server. The secondary storage server is typically known as a backup server, but may perform backup, archive, hierarchical storage management tasks, and object storage. Deduplication is used in data storage environments where different versions of files are stored.

Deduplication is also used in communication environments in which deduplication is used to reduce the amount of data communication required. Such communication environments may include primary storage or WAN accelerators where deduplication is used for data efficiency. In WAN accelerators, blocks of data may be stored locally on either side of a WAN communication and only references to deduplicated blocks need to be sent for data efficiency. The described method may be used for identifying suspicious blocks of data being communicated in the WAN.

In storage environments, the described method identifies where deduplication patterns exist inside files and servers in their versions over time in order to allow for the malware to be detected across the storage environment. A similar method can be used in other environments that use deduplication processors by identifying data with deduplication patterns that match those of known or suspected malware data.

The detection of malware is an improvement in the technical field of computer security generally and, more particularly, in the technical field of backup storage systems and other deduplication environments. Some recent malware examples have been observed in the 10s of MB. This therefore brings the size of these files well within the realm of deduplication technologies, which typically use block sizes measured in a few KB.

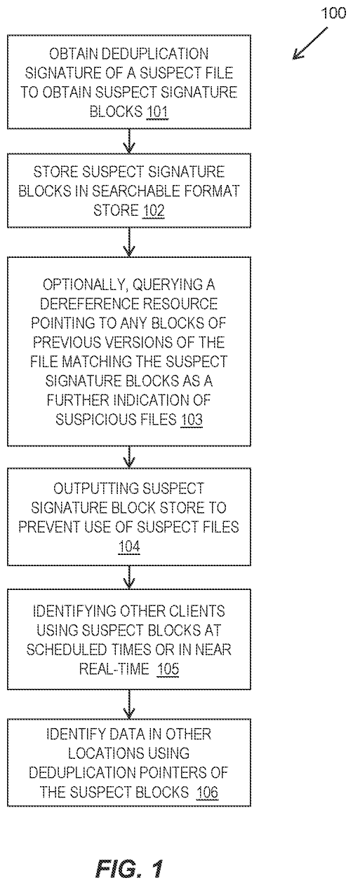

Referring to FIG. 1, a flow diagram 100 shows an example embodiment of a computer-implemented method for detection of malware.

The method may obtain 101 a deduplication signature of a file identified as being suspicious to obtain multiple suspect signature blocks. A signature may be a hash or other form of unique identification of the data used in deduplication. Deduplication patterns are provided by the multiple suspect signature blocks that can be identified in a system in order to identify other instances of potentially suspect data.

The method may store 102 the suspect signature blocks in a searchable format store. In the example embodiment, this is called a “known suspect block hash table”.

Optionally, the method may query 103 a dereference resource, such as a “dereferenced hashes table” or “deref table”, to find any previous versions of files or data referencing the suspect signature blocks. Dereference resources are provided to store information about blocks of data that are no longer current. A comparison of current suspect signature blocks with previous versions may be used as an optional method of identifying code that is changing giving further indication that it is suspicious. For example, code that is morphing, self-encrypting, or concealing will change over time. Code that is changing, or self-encrypting can identify itself by replacing the same parts of a file, meaning that references required to create a file are removed, even though it is replacing them with unique blocks.

The dereference resource stores information about blocks which are no longer required to construct the current version of a file. If a file has been identified with malware, the file is compared to how it deduplicated previously. Some blocks will be different, the blocks that are no longer needed to represent the malware infected version of the file will have their hashes stored in the deref table as these are the hashes that may indicate the presence of malware in other files or systems. Alternatively, the known suspect block hash table may include an index of previous versions that can be searched against.

In other embodiments, the method may be used without the dereference resource to identify malware. This may be used to identify possible locations of suspicious blocks of data without the further test for morphing code. Other additional tests may be carried out on the identified suspicious blocks.

The method may output 104 the suspect signature block store for reference to prevent use of suspicious data blocks. Access may also be provided to the dereference resource.

The method may identify 105 other clients using the suspect blocks at scheduled times or in near real time. This may use different methods for identifying static code and identifying morphing code. This may query deduplication pointer tables to identify 106 the files referencing the suspect signature blocks.

Identifying use of suspect blocks for static code may be by a database query to determine if the signatures in the suspect signature store are referenced by other clients' data, for example, stored by a backup server.

Identifying use of suspect blocks for morphing code in a storage environment may include the following steps. The dereference table is used to create a list of dereferenced signatures with a list of associated still-referenced signatures for the same file. The deduplication database is used to make a list of clients where all or a statistically significant number of the still referenced signatures exist in the current version. If the clients in this list have the dereferenced signatures still referenced the same number of times as the still referenced signatures within configurable tolerance (i.e., responsive to determining that clients in this last have the dereferenced signatures still referenced the same number of times as the still referenced signatures within configurable tolerance), these clients are removed from the list as likely not infected.

Testing may also be carried out of the blocks which have replaced the dereferenced blocks to test for encryption. Tests for encryption may use methods such as randomness tests, chi squared analysis, Shannon entropy, etc., giving higher confidence that they are infected with polymorphic code.

In embodiments of storage environments, preventing use may identify suspect signature blocks existing inside files and servers in their different storage copies over time before restoring them. The method may obtain signatures that represent the blocks of previously backed up version of the file from the backup server's database; and may compare these to the stored signatures, allowing dereferenced signatures to be stored in a dereferenced table alongside the still referenced signatures.

In embodiments in which the method is implemented in non-storage environments, this may allow blocking endpoints which have indications of suspect code present.

In embodiments of data protection, the method may be implemented by integrating into a data protection environment via access to the suspect signature store hosted in a common database.

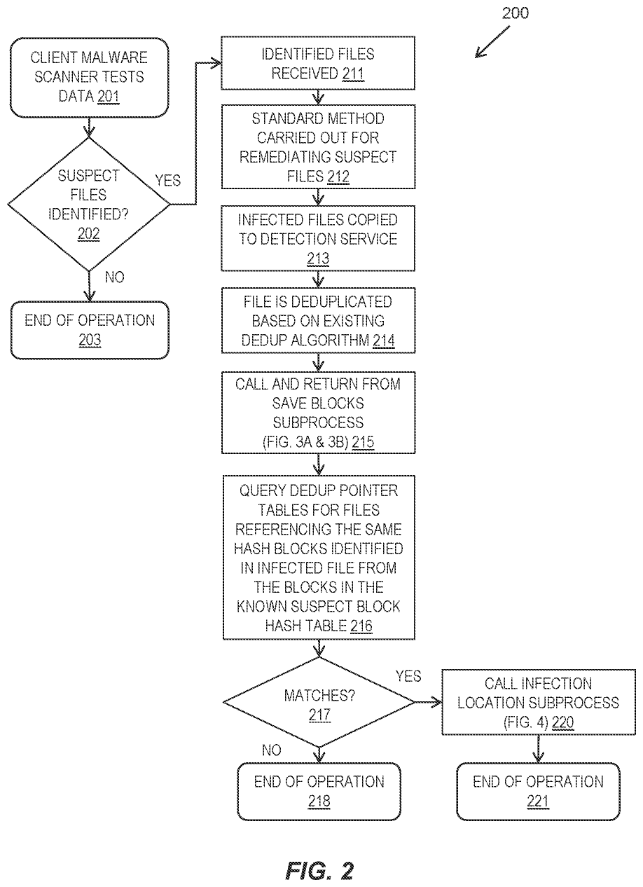

Referring to FIG. 2, a flow diagram 200 shows an example embodiment of an aspect of the described method. The example embodiment is described in the context of a backup storage environment. For example, the method may be performed by one or more components of a malware detection system code discussed in greater detail below.

An existing security system may be used 201, such as a client malware scanner to test data. It may be determined 202 whether suspicious files are identified. If there are no suspicious files, the method may end 203 until the next scan. If there are suspect files identified, the method proceeds to receiving the identified files 211.

At a high level the data protection server operates as normal, until a file which is infected is encountered. Infected files are identified to the backup client software by an identification method. The identification method may be, as examples, a malware scanner, other security software, or manually by the organization's security team. Standard methods may be carried out 212 for remediating the identified suspect files.

In normal operations, if an infected file is identified, it can be passed to the backup server by various methods automatic and manual which are not limited to the backup process details provided above.

The infected files may be copied 213 to a detection service, such as at a backend server, with a method to identify the file as “infected”. The identification may be a flag presented with a file passed from a backup command or a dedicated object store hosted on the backup server.

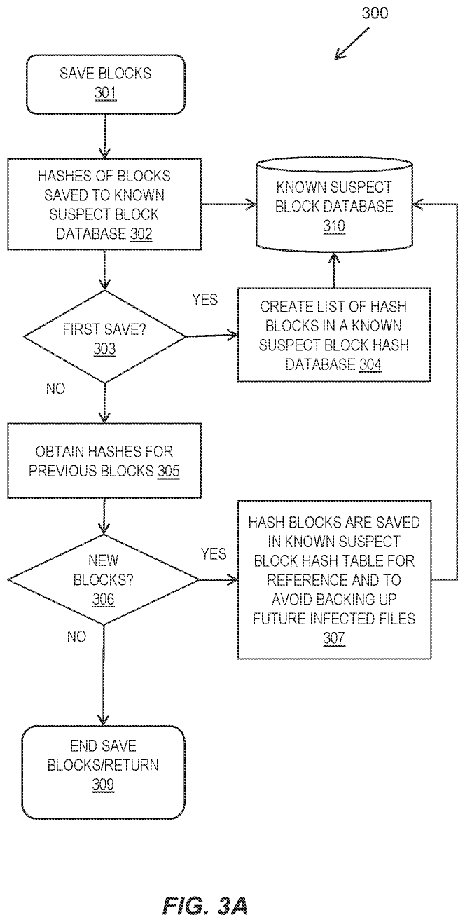

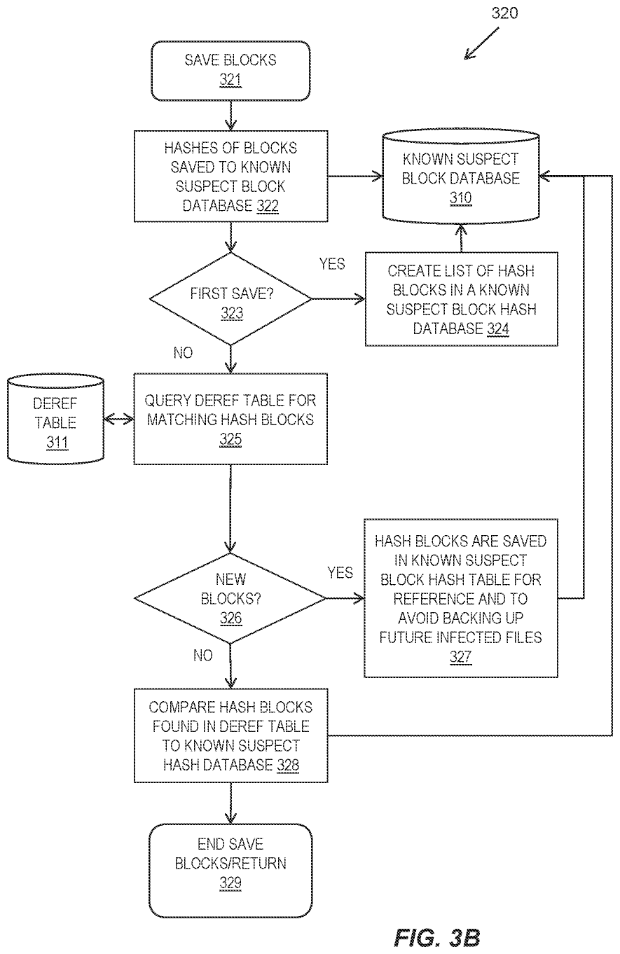

The identified file is deduplicated 214 as normal, using the existing deduplication algorithm in the environment. The method carries out 215 a call and return subprocess as described in FIGS. 3A and 3B below to save suspect signature blocks (for example, hash blocks) to a searchable store. The searchable store may provide a malware hash block table and may optionally provide a dereference table for the blocks.

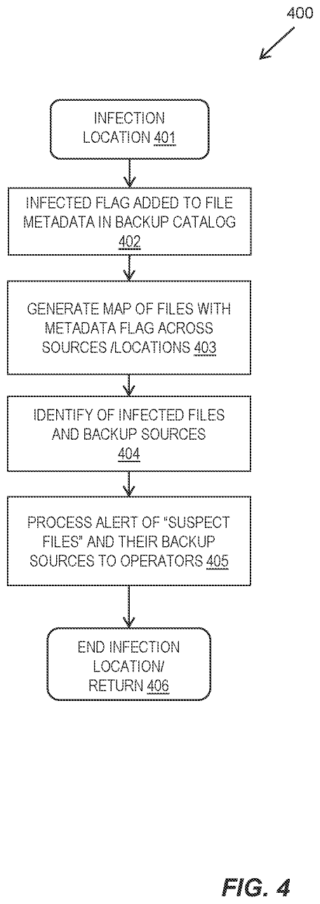

Once the known malware hash block table is populated, a sub-process to identify other clients using common blocks is either scheduled or run in near real time. The method may query 216 deduplication pointer tables for files referencing the same hash blocks identified in the infected file from the hash block table. It is determined 217 if there are matches and, if so, the method calls an infection location subprocess 220 as described below with reference to FIG. 4. If there are no matches, or after the infection location subprocess is called, the method ends the operation 218, 221.

Referring to FIG. 3A, a flow diagram 300 shows a first embodiment of an aspect of the described method of building the suspect block database.

A save blocks subprocess may start 301 when a deduplicated file is available for a suspect file. Details of the signature blocks which represent the file are stored in a searchable format. In one embodiment, hashes of the blocks are saved 302 to “known suspect block database” 310. However, the searchable format may be in one of multiple different formats. Other embodiments may store the suspect signature blocks in a text file or spreadsheet.

It is determined 303 if this is a first save of the block. If so, the method creates 304 a list of hash blocks in the known suspect block database 310.

If the hash block is not a first save, the hashes that represent the blocks of the previously backed up version of the file are obtained 305 from the backup server's database and compared to the presented version to determine 306 if there are new blocks. New blocks may be data that has not been deduplicated before and therefore does not exist in the existing tables. If so, hash blocks are saved in the known suspect block database 310 and in the deref table 311 for reference and to avoid backing up future infected files 307. If no new blocks are found in step 306 (i.e., determine 306), the method may end 309 the save blocks subprocess and return.

Referring to FIG. 3B, a flow diagram 320 shows a second embodiment of an aspect of the described method of building the known suspect block database 310 and deref table 311.

A save blocks subprocess may start 321 when a deduplicated file is available for a suspect file. Details of the signature blocks which represent the file are stored in a searchable format. In one embodiment, hashes of the blocks are saved 322 to “known suspect block database” 310. However, the searchable format may be in one of multiple different formats.

It is determined 323 if this is a first save of the block. If so, the method creates 324 a list of hash blocks in the known suspect block database 310.

If the hash block is not a first save, the hashes that represent the blocks of the previously backed up version of the file are obtained 325 from the backup server's database and compared to the presented version, allowing dereferenced hashes to be stored in a deref table 311.

It is then determined 326 if there are new blocks. New blocks may be data that has not been deduplicated before and therefore does not exist in the existing tables. If so, hash blocks are saved in the known suspect block database 310 and in the list for reference and to avoid backing up future infected files 327. If no new blocks are found in step 326 (i.e., determine 326), the method may compare 328 the hash blocks found in the deref table 311 to known suspect block database 310. The method may end 329 the save blocks subprocess and return.

Referring to FIG. 4, a flow diagram 400 shows an aspect of the described method of the subprocess of infection location identifying. Once the known malware hash table and, optionally, the deref table are populated, a sub-process to identify other clients using common blocks is either scheduled or run in near real time. This process is identified as the “infection location subprocess”. The infection location subprocess may have different methods for static and for morphing code that carry out the following steps.

The infection location subprocess may start 401 with an infected flag added 402 to file metadata in a backup catalog. The method may generate 403 a map of files with metadata flags across sources and locations. The method may identify 404 infected files and backup sources and may process 405 an alert of the suspect files and their backup sources to operators. The infection location subprocess may then end 406 and return.

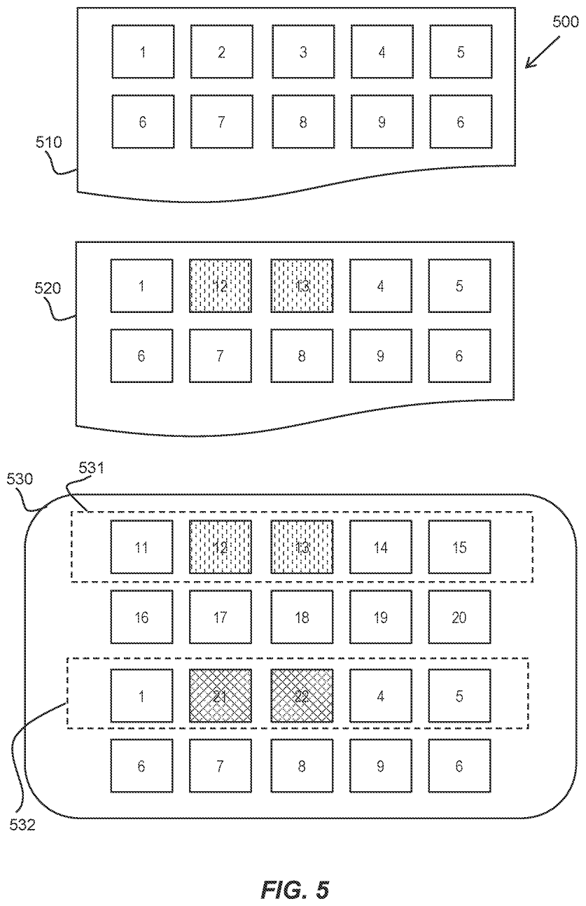

FIG. 5 shows a schematic diagram 500 illustrating the described method by showing schematically a blocks, files, and snapshots diagram. A file is shown pre-infection 510 with 10 blocks and post infection 520 with infected blocks 12 and 13. A later unrelated file 530 or snapshot is shown in which the infected blocks may be detected.

For static code, a database query is used to see if the hashes in the malware hash table are referenced by other clients' data stored by the backup server. This can be seen in the file 530 with callout 531 where blocks 12 and 13 are referenced suggesting a strong signal of malware.

For morphing code, the dereference table is used to create a list of dereferenced hashes with a list of associated still-referenced hashes for the same file. The deduplication database is then used to make a list of clients where all of the still referenced hashes exist in the current backup. If the clients in this list have the dereferenced hash/hashes still referenced the same number of times as the still referenced hashes (within configurable tolerance) these clients can be removed from the list as likely not infected. This can be seen in file 530 with callout 532 where blocks 21 and 22 are replacing dereferenced blocks 2 and 3 and are in fact obfuscated versions of blocks 12 and 13. The dereferencing of these blocks around the existing blocks 1, 4 and 5 sends a strong signal for malware infection.

A number of optional additional tests may be added, such as testing the blocks which have replaced the dereferenced blocks to indicate encryption, giving higher confidence that they are infected with polymorphic or self-encrypting code. Such tests may include randomness testing, chi squared, Solomon Entropy, etc.

There are several other uses for deduplication in computing, such as WAN acceleration. The method may be implemented in these technologies as a separate standalone system or integrated into a data protection environment's existing implementation via access to the “bad hash tables” hosted in a common database. This would allow blocking endpoints which have indications of malware present.

Advantages of this proposed method and system are discussed below. The method and system provide rapid mass detection of malware using deduplication signatures. This may be applied where deduplication handling is carried out, including data storage or data communication.

The method enables identification of files storing malware in different formats, such as those traditionally not scanned (for example, text, non-executables, etc.) because they contain common blocks of the malware data.

The method also enables identification of malware in backup or archives of storage systems which cannot typically be scanned for malware quickly or easily, thus identifying infections on the product hardware. Such storage systems may include, but are not limited to object stores, identical storage file images, block based snapshots such as virtual machine/array based systems, Network Data Management Protocol images, or virtual machine image backups.

The method also enables identification of malware which are stored on out-of-support operating systems, or unsupported filesystems, by means of identification of the data blocks, rather than ability to run a malware scanner.

The malware types which are able to be scanned may include traditional static code, but also metamorphic code which re-writes itself and polymorphic code which encrypts elements of itself so as to attempt to evade detection.

This system is further advanced by easily retro-fitting to any malware scanner as the procedure to enact if an infected file is found is the command line backup command to backup the same file. This makes it more easily implemented than an API call from the malware scanner to the backup environment, although this would also be available.

The method also provides the ability to identify malware based on the previous version of a file backed up, then to extrapolate that information across all data stored on the server and not just the client type, backup type and older unsupported versions of clients, etc.

The method provides detection across every backup stored on the server in a deduplication environment. Furthermore, it can identify data which are in unsupported system or file types. In addition, the method needs to know nothing of the data which it has backed up; it is not required for the backup server to be able to read individual files/data making it inherently more secure, as global data is not scanned by a single user context.

The method does not do any scanning on the locally stored data. A file or Binary Large Object (BLOB) which is flagged as malware by a production malware scanner is given to the server, typically via a backup agent although it could be by other method. The server then works out itself what the malware looks like comparing a previous “clean” version of the file from a previous backup and working out what the referenced/dereferenced blocks were. The result being rapid identification across the whole of the deduplication domain based on a single file's presentation and the references to previously backed up version of the file and not based on any time-consuming scanning or locally installed antivirus software.

The method may also be used for scanning for malware going through a WAN accelerator.

The backup server in the disclosure does not need to have an anti-virus scanner installed, no time consuming and system resource draining malware scanning is required at the server, rather a rapid query for the deduplication hashes in a database (for example, a Relational Database Management System (RDBMS).

Lack of requirement to actually read and analyze the data itself at the backup server, rather just the metadata, means that zero-trust can be established as the backup server needs to have no knowledge of the contents of the data.

The system can identify normal static code, polymorphic and self-encrypting malware, through the use of the deref functionality. The system can identify malware in system snapshots, virtual machine snapshot-backups, filesystem images (such as CD ISOs, etc.). This can work across operating systems and architectures in the clients.

The method uses the backup system's own deduplication algorithm to identify what the hashes of malware look like then matches those to the query for the hashes in the searchable database.

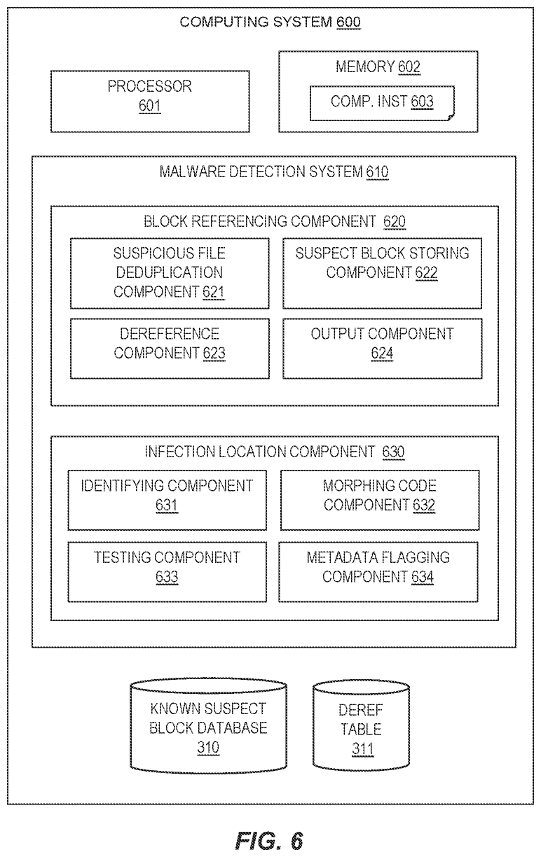

Referring to FIG. 6, a block diagram shows a computing system 600 on which aspects of the described system may be implemented including a malware detection system 610.

The computer system 600 includes at least one processor 601, a hardware module, or a circuit for executing the functions of the described components which may be software units executing on the at least one processor. Multiple processors running parallel processing threads may be provided enabling parallel processing of some or all of the functions of the components. Memory 602 may be configured to provide computer instructions 603 to the at least one processor 601 to carry out the functionality of the components.

The malware detection system 610 includes a block referencing component 620 for generating and populating a suspect signature block store, for example, in the form of a known suspect block database 310 including a list of hash blocks. The block referencing component 620 may, optionally, include a dereference resource in the form of a deref table 311. The known suspect block database 310 may be accessed by an infection location component 630 of the malware detection system 610 to locate other clients' files using the suspect data.

The block referencing component 620 may include a suspicious file deduplication component 621 for obtaining a deduplication signature of a file identified as being suspicious to obtain a plurality of suspect signature blocks. This may be obtained from an existing deduplication processing system. The block referencing component 620 may include a suspect block storing component 622 for storing the suspect signature blocks in a searchable format store. The block referencing component 620 may include a dereference component 623 for accessing a dereference resource for querying pointing to previous versions of the suspect signature blocks of data to determine when code has changed indicating suspicious code. The block referencing component 620 may include an output component 624 for outputting the suspect signature block store and, optionally, the dereference resource for identification of other instances of the suspect data blocks.

In an embodiment of a backup environment, the dereference component 623 points to the suspect signature blocks existing inside files and servers in their different backup copies over time. The dereference component 623 may include: obtaining signatures that represent the blocks of previously backed up versions of the file from the backup server's database; and comparing these to the stored signatures and allowing dereferenced signatures to be stored in a dereferenced table alongside the still referenced signatures.

The infection location component 630 may include an identifying component 631 for identifying data in other clients using suspect blocks by using deduplication pointers to determine where the signatures in the suspect signature block store are referenced by other clients' data. The identifying component 631 is scheduled to identify other clients using suspect blocks at scheduled times or in near real time.

The identifying component 631 may include a morphing code component 632 for handling morphing code including: using the dereference resource to create a list of dereferenced signatures with a list of associated still-referenced signatures for the same file; using a deduplication database to make a list of clients where all of the still referenced signatures exist in the current backup; and, if the clients in this list have the dereferenced signatures still referenced the same amount of times as the still referenced signatures within configurable tolerance, these clients are removed from the list as likely not infected.

The identifying component 631 may include a testing component 633 for testing the blocks which have replaced the dereferenced blocks for randomness to indicate encryption, giving higher confidence that they are infected with polymorphic code.

The infection location component 630 may include a metadata flagging component 634 for: adding a flag to file metadata in a backup catalog indicating suspect files; generating a map of files with metadata flags across sources and location to identify suspect files; and providing an alert.

The infection location component 630 may be implemented by integrating into a data protection environment via access to the suspect signature store hosted in a common database or in environments to allow blocking of endpoints which have indications of suspect code present.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

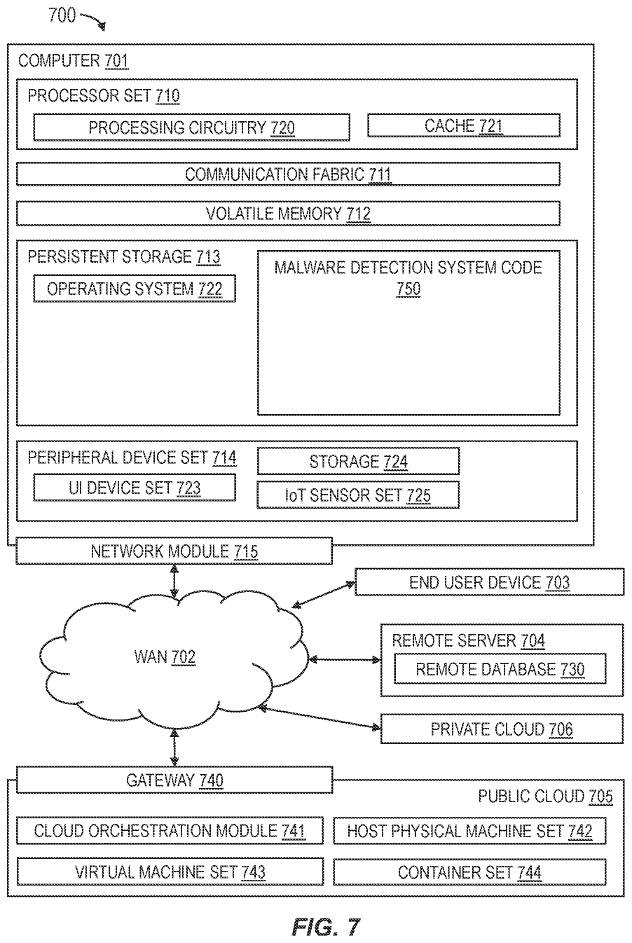

Referring to FIG. 7, computing environment 700 contains an example of an environment for the execution of at least some of the computer code involved in performing the inventive methods, such as malware detection system code 750. In addition to block 750, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 750, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 750 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code included in block 750 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

What is claimed is:

1. A computer-implemented method for detection of malware, said method comprising:
obtaining a deduplication signature of a file identified as being suspicious to obtain a plurality of suspect signature blocks;
storing the plurality of suspect signature blocks in a searchable format store; and
outputting a suspect signature block store for use in identification of other instances of suspect signature data blocks.

2. The computer-implemented method of claim 1, further comprising:
identifying data in other locations using the plurality of suspect signature blocks by using deduplication pointers to determine where signatures in the suspect signature block store are referenced by other data.

3. The computer-implemented method of claim 1, further comprising:
identifying other clients using suspect signature blocks at scheduled times or in near real time.

4. The computer-implemented method of claim 1, further comprising:
querying a dereference resource pointing to previous versions of suspect signature blocks of data of the plurality of suspect signature blocks to determine when code has changed indicating suspicious code.

5. The computer-implemented method of claim 4, further comprising:
obtaining signatures that represent signature blocks of previously backed up versions of the file from a backup server's database; and
comparing these to the stored plurality of suspect signature blocks and allowing dereferenced signatures to be stored in a dereferenced table to be compared to still referenced signatures.

6. The computer-implemented method of claim 4 further comprising:
identifying for morphing code wherein identifying for morphing code comprises:
using the dereference resource to create a list of dereferenced signatures with a list of associated still-referenced signatures for a same file;
using a deduplication database to make a list of clients where all or a statistically significant number of the still-referenced signatures exist in a current backup; and
responsive to determining that clients in the list where all or a statistically significant number of still-referenced signatures have dereferenced signatures still referencing a same number of times as the still referenced signatures within configurable tolerance, removing the clients that include all or a statistically significant number of still-referenced signatures have dereferenced signatures still referencing a same number of times as the still referenced signatures within configurable tolerance from the list as likely not infected.

7. The computer-implemented method of claim 6, further comprising:
testing blocks which have replaced the dereferenced blocks for encryption, giving higher confidence that they are infected with polymorphic code or self-encrypting code.

8. The computer-implemented method of claim 7, further comprising:
adding a flag to file metadata indicating suspect files;
generating a map of files with metadata flags across sources and location to identify suspect files; and
providing an alert.

9. The computer-implemented method of claim 1, including implementing the method by integrating into a data protection environment via access to the suspect signature store hosted in a common database.

10. The computer-implemented method of claim 1, including implementing the method in non-backup environments to allow blocking of endpoints which have indications of suspect code present.

11. A system for detection of malware, comprising:
a processor and a memory configured to provide computer program instructions to the processor to execute the function of the components:
a suspicious file deduplication component for obtaining a deduplication signature of a file identified as being suspicious to obtain a plurality of suspect signature blocks;
a suspect block storing component for storing the plurality of suspect signature blocks in a searchable format store; and
an output component for outputting a suspect signature block store for use in identification of other instances of suspect signature data blocks.

12. The system of claim 11, including:
an identifying component for identifying data in other locations using the suspect signature blocks by using deduplication pointers to determine where signatures in the suspect signature block store are referenced by other data.

13. The system of claim 12, wherein the identifying component is scheduled to identify other clients using suspect signature blocks at scheduled times or in near real time.

14. The system of claim 12, including a dereference component for querying a dereference resource pointing to previous versions of suspect signature blocks of data of the plurality of suspect signature blocks to determine when code has changed indicating suspicious code.

15. The system of claim 14, wherein the dereference component includes:
obtaining signatures that represent the blocks of previously backed up versions of the file from a backup server's database; and
comparing these to the stored plurality of suspect signature blocks and allowing dereferenced signatures to be stored in a dereferenced table to be compared to still referenced signatures.

16. The system of claim 14, wherein the identifying component includes a morphing code component for handling morphing code including:
using the dereference resource to create a list of dereferenced signatures with a list of associated still-referenced signatures for a same file;
using a deduplication database to make a list of clients where all or a statistically significant number of the still-referenced signatures exist in a current backup; and
responsive to determining that clients in the list where all or a statistically significant number of still-referenced signatures have dereferenced signatures still referencing the same number of times as the still referenced signatures within configurable tolerance, removing these clients from the list as likely not infected.

17. The system of claim 16, wherein the identifying component includes a testing component for testing blocks which have replaced the dereferenced blocks for encryption, giving higher confidence that they are infected with polymorphic code or self-encrypting code.

18. The system of claim 17, including a metadata flagging component for:
adding a flag to file metadata indicating suspect files;
generating a map of files with metadata flags across sources and location to identify suspect files; and
providing an alert.

19. The system of claim 11, implemented by integrating into a data protection environment via access to the suspect signature store hosted in a common database or in environments to allow blocking of endpoints which have indications of suspect code present.

20. A computer program product stored on a computer readable medium and loadable into the internal memory of a digital computer, comprising software code portions, when said program is run on a computer, for performing the method steps of:
obtaining a deduplication signature of a file identified as being suspicious to obtain a plurality of suspect signature blocks;
storing the plurality of suspect signature blocks in a searchable format store; and
outputting a suspect signature block store for use in identification of other instances of suspect signature data blocks.
